(19) United States
(12) Patent Application Publication
(10) Pub. No.: US 2016/0329170 A1
(43) Pub. Date: Nov. 10, 2016

(54) LOCK FOR A CIRCUIT BREAKER

(71) Applicant: EATON INDUSTRIES (AUSTRIA) GMBH, Schrems (AT)

(72) Inventor: Raffael Zimmel, Tulln (AT)

(21) Appl. No.: 15/036,443

(22) PCT Filed: Nov. 13, 2014
(86) PCT No.: PCT/EP2014/074542

§ 371 Date: Jul. 7, 2016

(30) Foreign Application Priority Data
Nov. 15, 2013 (DE) 10 2013 112 590.5

(51) Int. Cl. H01H 9/28

(52) U.S. Cl. CPC H01H 9/283

(57) ABSTRACT

A lock for a circuit breaker has a main body having a cutout to accommodate an actuating element of the circuit breaker. The lock has a projection which can be moved relative to the main body and can be brought into engagement with at least one opening/recess in the circuit breaker. To this end the projection is mounted in a slide which is displaceable relative to the main body and which slide extends obliquely relative to its direction of displacement and to the direction of displacement of the projection or has at least one such section.

### CROSS-REFERENCE TO RELATED APPLICATIONS

This application is a U.S. national stage application under 35 U.S.C. §371 of International Application No. PCT/EP2014/074542, filed on Nov. 13, 2014, and claims benefit to German Patent Application No. DE 10 2013 112 590.5, filed on Nov. 15, 2013. The International Application was published in German on May 21, 2015, as WO 2015/071382 A1 under PCT Article 21(2).

### FIELD

The invention relates to a circuit breaker and lock arrangement and a circuit breaker having an actuating element for switching the circuit breaker on and off.

### BACKGROUND

DE 10 2010 020 987 A1 discloses a circuit breaker comprising a lock for enclosing the toggle switch in its off position by means of a protective cover. The lock allows the circuit breaker to be locked, for example in order to be able to carry out work safely on the lines connected to the circuit breaker concerned. To this end, the slide of the switching mechanism has a threaded hole and the lock has a through hole through which a head screw which fixes the lock on the switch housing reaches to the slide. Here, the toggle switch can be enclosed by the protective cover only in the off position such that the through hole also aligns with the threaded hole and the lock can be installed. A shackle lock or a padlock can be installed in a drilled hole in the lock and the head screw locked against further access.

A disadvantage with the known lock is that access to the head screw is also possible under certain circumstances if a shackle lock having a relatively thin shackle is installed. By using a slim screwdriver the lock could be dismantled by unauthorized persons despite being locked and the circuit breaker could be actuated. Serious accidents such as a fire caused by a short circuit or flying sparks and serious injuries even resulting in death can be the consequence.

A further disadvantage of the known lock is that it is constructed from a plurality of parts and due to the screw can only be installed laboriously. In particular on construction sites, where the ground is very dirty, finding a dropped screw is also not possible or only possible in a very time-consuming manner.

U.S. Pat. No. 6,791,040 B1 also discloses a lock, which is fixed to an elevated region of the circuit breaker. This is likewise made of a plurality of parts and likewise difficult to install even if no screwdriver is needed to do so. The problem here appears to be that the three parts of the lock have to be aligned with the actuating element of the circuit breaker. Furthermore, the lock can be installed in the ON position and in the OFF position of the actuating element. Moreover, as also in DE 10 2010 020 987 A1, the shackle of the shackle lock must have a certain diameter so that the lock cannot be removed despite the installed shackle lock. All in all, certain expert knowledge and attention during installation is required for the installation of the lock disclosed in U.S. Pat. No. 6,791,040 B1. Mounting of the lock by auxiliary personnel entails risks which cannot be justified per se.

Finally, EP 0 412 023 B1 discloses a lock, which can be installed only in the case of a properly functioning circuit breaker having open switch contacts but not having closed switch contacts or if its switch contacts have been welded by excessively high currents.

### SUMMARY

An aspect of the invention provides an arrangement, comprising: a circuit breaker including an actuating element configured to switch the circuit breaker on and off; and a lock including a main body including a cutout configured to receive the actuating element and including a projection, which can be moved relative to the main body and corresponds to an opening or recess in the circuit breaker and can be brought into engagement with the opening or recess, wherein the projection is mounted in a slide which is displaceable relative to the main body and extends obliquely relative to its direction of displacement and to the direction of displacement of the projection or has at least one such portion.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1a is a front view of an arrangement by way of example comprising a circuit breaker and a lock installed thereon together with shackle lock;

FIG. 1b is a side view of the arrangement in FIG. 1a;

FIG. 2a is a sectional view of the arrangement in FIG. 1;

FIG. 2b is as FIG. 1b, but slightly larger;

FIG. 3 is a detailed, oblique view of the arrangement in Fig. 1a;

FIG. 4 is an illustration of an attempt to install the lock in a position of the actuating element of the circuit breaker for which the lock is not intended; and

FIG. 5 is as FIG. 4, but having a lock that has been rotated by 180°.

### DETAILED DESCRIPTION

An aspect of the invention relates to an arrangement comprising: a circuit breaker having an actuating element for switching the circuit breaker on and off; and a lock comprising a main body having a cutout for receiving said actuating element of the circuit breaker and comprising at least one projection that can be moved relative to the main body and corresponds to at least one opening or recess in the circuit breaker and can be brought into engagement therewith.

An aspect of the invention relates to a lock for a circuit breaker, comprising: a main body, which has a cutout for receiving an actuating element of the circuit breaker; and at least one projection that can be moved relative to the main body and corresponds to at least one opening or recess in the circuit breaker and can be brought into engagement therewith.

An aspect of the invention provides an improved lock or improved arrangement comprising a lock and a circuit breaker. In particular, it is possible to install the lock intuitively and if possible, without tools.

An aspect of the invention provides an arrangement in which the at least one projection is mounted in a slide, which is displaceable relative to the main body and extends obliquely relative to its direction of displacement and to the direction of displacement of the projection or has at least one such portion.

Furthermore, an aspect of the invention provides a lock of the type mentioned at the outset, in which the at least one projection is mounted in a slide, which is displaceable relative to the main body and extends obliquely relative to its direction of displacement and to the direction of displacement of the projection or has at least one such portion.

As a result of the proposed measures, the lock can be installed on the circuit breaker intuitively and basically without tools. Here, a movement of the slide in the direction of displacement brings about a movement, in particular a displacement, of the projection mounted therein transversely to said direction of displacement. The at least one projection engages in the active position in at least one opening or recess in the circuit breaker, and then impedes or prevents a movement of the lock relative to the circuit breaker.

Fundamentally, it can be provided for the projection that has been brought into engagement to prevent a relative movement between lock and circuit breaker in all three directions of movement or only in one direction of movement or only in two directions of movement. For example, it is advantageous if a movement of the lock relative to the circuit breaker is impeded or prevented by the projection in a horizontal direction or transversely to an actuation direction of the actuating element. Fundamentally, a relative movement between lock and circuit breaker can be prevented in other ways in certain directions. For example, a bar-like protrusion of the lock/of the circuit breaker can interact with a groove in the circuit breaker/in the lock and in this way prevent a relative movement between lock and circuit breaker in one direction of movement. Here, the projection is brought into engagement with the groove by placing the lock on the circuit breaker. By the same principle, for example, a pin-like protrusion of the lock/of the circuit breaker can interact with a blind-hole-like recess in the circuit breaker/in the lock and in this way prevent a relative movement between lock and circuit breaker in two directions of movement.

Generally, it is conceivable that just one movable projection engages in an opening or recess in the circuit breaker as a result of a movement of the slide. It is, however, also conceivable for a plurality of projections to engage in a plurality of openings/recesses in the circuit breaker. In particular, it is conceivable that projections on both sides of the main body can be moved out of said main body and brought into engagement with openings or recesses in the circuit breaker, in particular if the slide is arrow-shaped. The projections are then moved (at least partially) in a mirror-inverted manner.

Directions such as “vertical” and “horizontal” relate to the customary installation position of the circuit breaker (for example, in a walled-in switch box), in which the actuation direction of the actuating element of the circuit breaker is vertically aligned. If the installation position is changed, the directions are to be adjusted accordingly notionally.

Advantageous embodiments and developments of the invention can be found in the dependent claims and from the description viewed together with the drawings.

It is favorable for the at least one projection to be formed by a pin that is displaceable relative to the main body of the lock. In this variant, the projection which is formed by said pin can be extended and retracted, as a result of which the lock can be fixed conveniently to the circuit breaker or released therefrom.

Furthermore, it is advantageous if
the circuit breaker has a housing, terminals arranged inside the housing, openings provided in the housing for actuating the terminals and a region that is elevated relative to said openings and in which the actuating element for switching the circuit breaker on and off is arranged, and
the main body of the lock encloses said elevated region of the circuit breaker, in particular at the top and bottom respectively at edges of the elevated region which face end positions of the actuating element.

As a result of the measures referred to, a movement of the lock in a vertical direction or in the direction of movement of the actuating element is particularly well prevented. Moreover, the protrusions can contribute to slightly relieve the movable projections/pins.

It is advantageous if the actuating element for switching the circuit breaker on and off is arranged in the elevated region asymmetrically and off-center, in particular in relation to the vertical extension of the elevated region and
the cutout for receiving said actuating element of the circuit breaker is arranged asymmetrically and off-center in the main body of the lock in relation to the elevated region in particular in relation to the vertical extension of the elevated region of the circuit breaker and in relation to the region lying between the protrusions.

As a result of the asymmetrical arrangement of the cutout for the actuating element of the circuit breaker, it can be ensured that the lock can be installed only in the OFF position (or alternatively in the ON position). Installation of the lock in a position other than the intended position is practically impossible.

The lock can therefore be operated intuitively and can therefore also be used safely by untrained personnel.

As mentioned, the directions relate to the customary installation position of the circuit breaker. If the circuit breaker is installed horizontally, then the actuating element for switching the circuit breaker on and off is accordingly arranged asymmetrically and off-center in relation to the horizontal extension of the elevated region. Generally, the actuating element for switching the circuit breaker on and off is arranged asymmetrically and off-center in relation to the extension of the elevated region in the actuation direction of the actuating element.

The terms “asymmetrically” and “off-center” mean, within the scope of the invention, in particular that the pivot point of a rotatably mounted actuating element is not arranged in the center of the elevated region and that the positions of the actuating element in the on and the off position are not arranged mirror symmetrically about an axis extending through the center of the elevated region. The latter applies, for example, even if the actuating element is mounted displaceably.

Moreover, it is advantageous if the at least one opening or recess in the circuit breaker, which corresponds to the at least one projection, is arranged asymmetrically and off-center. In this way (in addition to or alternatively to the aforementioned version) it can also be ensured that the lock can be installed on the circuit breaker only in a certain position. In particular, installation of the lock in a position which is rotated by 180° relative to the permissible position is to be prevented.

In a further advantageous embodiment of the invention, the slide can be actuated with the aid of a rotatably mounted lever. As a result, a transmission between the movement of the slide and of the lever can be achieved and so the lever for example has to be swiveled far out in order to bring about a relatively small movement of the slide.

It is advantageous if a slide shifter comprising the slide and/or said lever has a recess, which can be moved out of the main body by moving the slide shifter/the lever or can be aligned with an opening in the main body. The slide or the lever can thus be fixed in position relative to the main body by an element that prevents movement (for example a bolt or pin) being passed through said recess. To this end, in a first variant, an opening in the slide shifter or in the lever is simply moved out of the main body. An element, which prevents movement and is fixed therein, would then occur on the outside of the main body and prevent a movement of the slide/of the lever into the original position. In the second variant, an opening in the slide shifter or in the lever is aligned with an opening in the main body and then an element that prevents movement is passed through both openings. Finally, it is also conceivable for the main body to have an opening past which the slide shifter and/or the lever can be moved. An element which prevents movement and is fixed therein would then occur on the outside on the slide and/or with the lever and prevent a movement of the slide/of the lever into the original position. For example, drilled holes, slots, elongated holes and similar can be considered as openings.

Finally, it is favorable for the arrangement to have a shackle lock passed through the opening. A movement of the lever can thus be prevented and the lock therefore secured against unauthorized opening or removal.

It should be noted here that the proposed alternatives to the disclosed arrangement and the resultant advantages relate equally to the disclosed lock and vice versa.

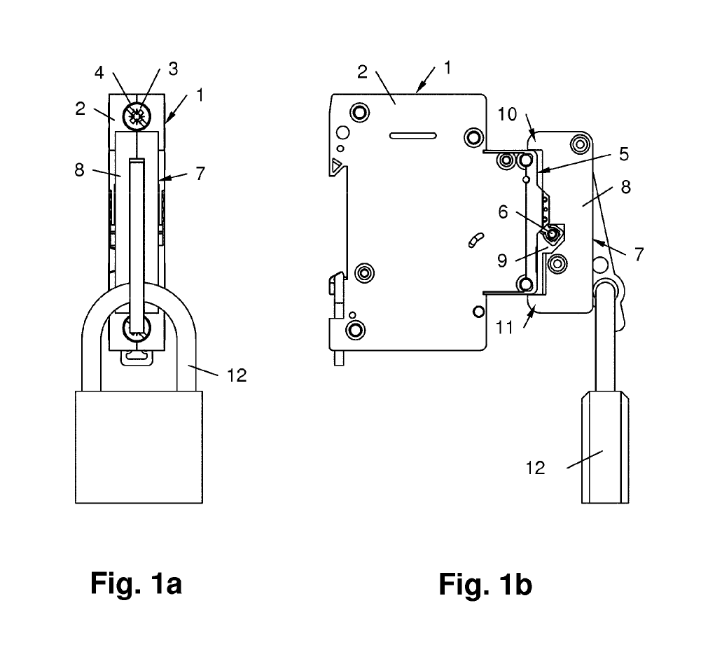

FIG. 1a is a front view and FIG. 1b is a side view of an arrangement according to the invention comprising a circuit breaker 1 and a lock 7. The circuit breaker 1 comprises a housing 2, terminals 3 arranged inside the housing 2, openings 4 provided in the housing 2 for actuating the terminals 3 and an optional region 5, which is elevated relative to said openings 4, in which an actuating element 6 for switching the circuit breaker 1 on and off is advantageously arranged off-center. The lock 7 comprises a main body 8 which has a cutout 9 for receiving said actuating element 6 of the circuit breaker 1. The main body 8 also has protrusions 10 and 11 on the upper and lower end, which enclose said elevated region 5 of the circuit breaker 1 at the top and bottom. While these are advantageous to the invention they are not absolutely necessary. Finally, FIG. 1a and 1b show an optional shackle lock 12 installed on the lock 7.

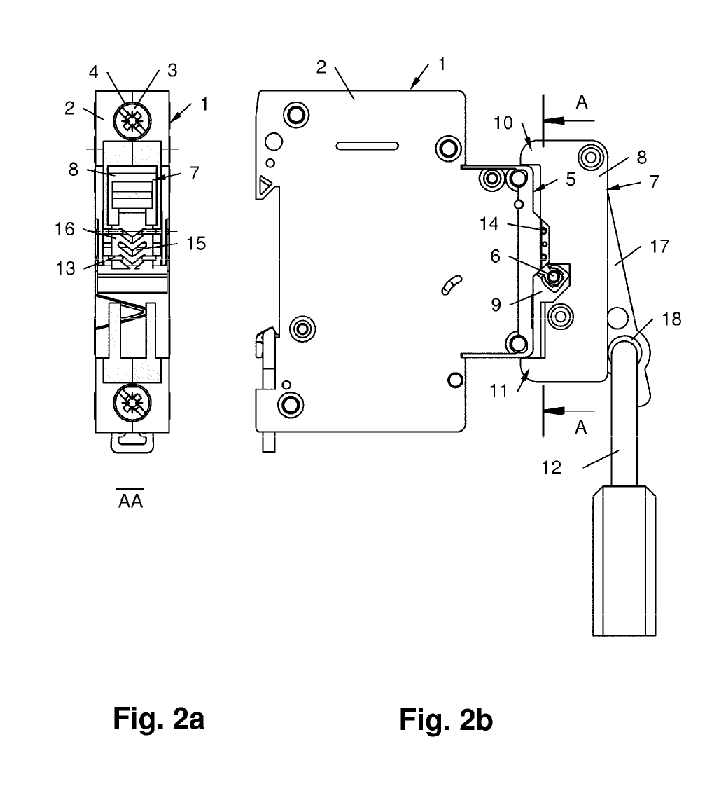

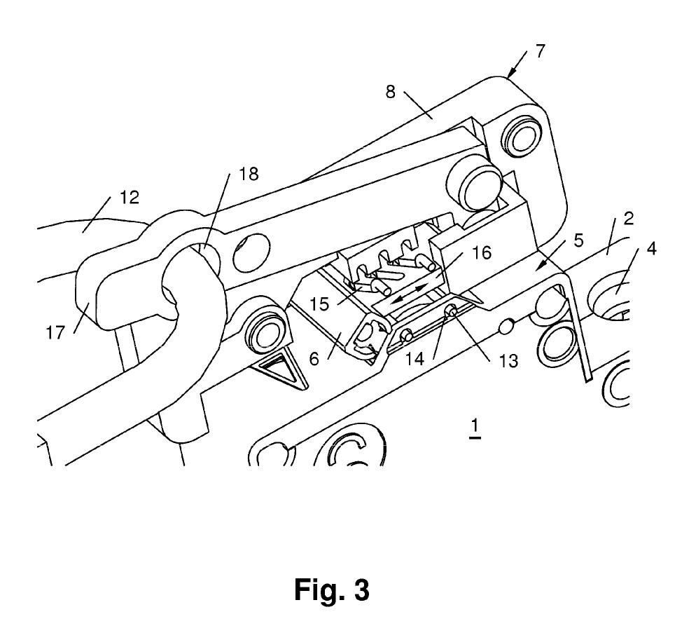

As well as the elements already mentioned, the lock 7 has at least one projection 13, which can be moved relative to the main body 8 thereof and corresponds to at least one opening 14 or recess in the circuit breaker 1 and can be brought into engagement therewith. FIGS. 2a and 2b show details of the specific embodiment, FIG. 2b in turn showing the side view of the arrangement, FIG. 2a showing the section A-A. Moreover, FIG. 3 is a detailed view obliquely from above, in which one half of the main body 8 has been removed for a better view.

In this example, the at least one projection is formed by four pins 13, which can be displaced relative to the main body 8, as a result of which the lock 7 can be fixed to the circuit breaker 1 or removed therefrom conveniently and without tools. If the pins 13 are brought into engagement with the openings 14, then a movement of the lock 7 relative to the circuit breaker 1 is impeded or prevented. The lock 7 is thus more or less fixed in position on the circuit breaker 1.

In order to extend and retract the pins 13, they are mounted in slides 15, which are displaceable relative to the main body 8 and which extend obliquely relative to their direction of displacement (see the double arrow in FIG. 3) and to the direction of displacement of the pin 13. Specifically, the slides 15 in this example are arrow-shaped. A movement of the slides 15 in the direction of displacement brings about a movement of the pins 13 mounted therein transversely to said direction of displacement, as a result of which these can be extended from or retracted into the main body 8 on both sides.

In the example shown, the slides 15 are actuated with the aid of a rotatably mounted lever 17. As a result of this, a transmission between the movement of the slides 15 and of the lever 17 can be achieved and so only a small actuation force must act upon the lever 17. It would, of course, however, also be conceivable for the slide shifter 16 having the slides 15 arranged thereon to be directly actuated, i.e. displaced. For example, said slide shifter 16 can be guided out of the main body 8 for this purpose.

The lever 17 advantageously has an opening 18 which can be moved out of the main body 8 by a movement of the lever 17. The lever 17 can thus be fixed in position relative to the main body 8 by an element that prevents movement (for example, a bolt or pin or, as in the example shown, a shackle lock 12) being passed through said opening 18.

It is also conceivable for the opening 18 not to be arranged in the lever 17, but rather in the slide shifter 16. If this is displaced out of the main body 8, then the slide shifter 16 in turn can be fixed in position by an element which prevents movement. This arrangement is particularly advantageous if the slide shifter 16 is not actuated by means of a lever 17, but rather directly.

In a further variant, the slide shifter 16 and/or the lever 17 has an opening 18, which can be aligned with an opening in the main body 8 by moving the slide shifter 16/the lever 17. If an element which prevents movement is passed through the aligned openings in the slide shifter 16 and in the main body 8 or in the lever 17 and in the main body 8, then the lock 7 can in turn be secured on the circuit breaker 1.

Finally, it is also conceivable for the main body 8 to have an opening, past which the slide shifter 16 and/or the lever 17 can be moved. An element 12, which prevents movement and is fixed thereon, would then occur on the outside of the slide shifter 16 and/or with the lever 17 and prevent a movement of the slide shifter 16/of the lever 17 into the original position. Drilled holes, slots, elongate holes and the like come into consideration, for example, as openings 18 for all variants.

In the example shown, the actuating element 6 for switching the circuit breaker 1 on and off is arranged in the elevated region 5 asymmetrically and off-center, in this specific example in relation to the vertical extension of the elevated region 5. Likewise, the cutout 9 for receiving said actuating element 6 of the circuit breaker 1 in the main body 8 of the lock 7 is arranged asymmetrically and off-center in relation to the elevated region 5, again specifically in relation to the vertical extension thereof. In this example, the main body 8 also has protrusions 10 and 11 on the upper and lower end, which enclose said elevated region 5 of the circuit breaker 1 at the top and bottom. As a result of these advantageous but optional measures, a movement of the lock 7 in a vertical direction is prevented particularly well, and the pins 13 are slightly relieved as a result.

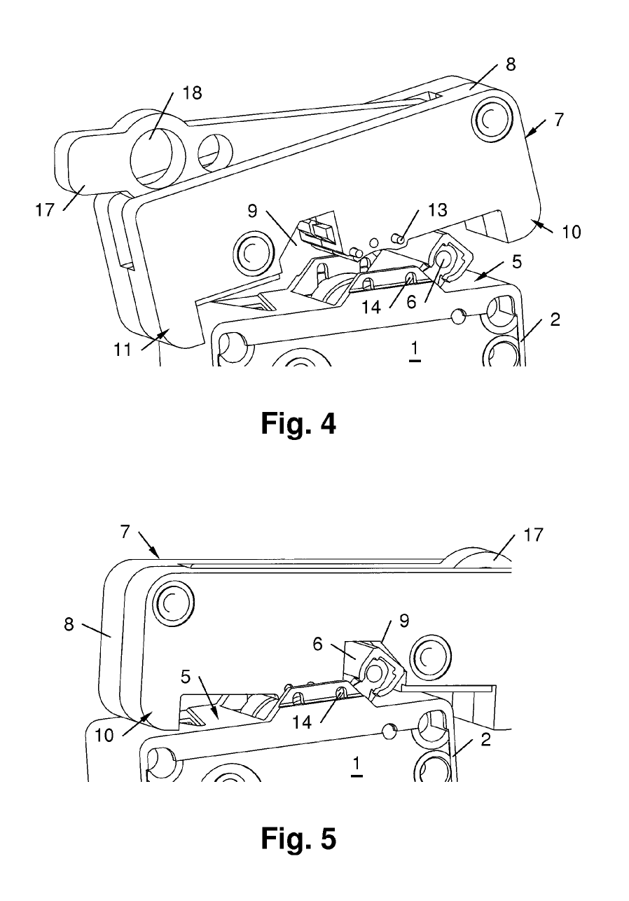

Furthermore, the lock 7 can be installed intuitively. As a result of the asymmetrical arrangement of the cutout 9 for the actuating element 6 of the circuit breaker 1, it can be ensured in particular that the lock 7 can be installed only in the OFF position (or alternatively in the ON position) of the actuating element 6 (see also FIGS. 4 and 5 in this regard). Installation of the lock 7 in a position other than the intended position is practically impossible. The lock 7 can therefore also be used safely by untrained personnel.

FIG. 4 is a detailed view of an arrangement comprising the circuit breaker 1 and the lock 7 in which an attempt was made to install the lock 7 in a position of the actuating element 6 for which the lock 7 is not intended. For example, the actuating element 6 is in the ON position even though the lock 7 is intended for installation only in the OFF position of the actuating element 6 (the opposite case would also be conceivable). As shown in FIG. 4, such an attempt fails - the lock 7 cannot be installed.

FIG. 5 shows another failed attempt to install the lock 7 in a position of the actuating element 6 for which the lock 7 is not intended. In this case, the lock 7 has been rotated by 180° relative to the position shown in FIG. 4. The lock 7 can thus be installed only in a position of the actuating element 6 for which the lock 7 is intended, i.e. in the position shown in FIGS. 1 to 3.

In addition or alternatively to the asymmetrical arrangement of the actuating element 6 and of the cutout 9, it can also be provided for the at least one opening or recess 14 in the circuit breaker 1, which corresponds to the at least one projection 13, to be arranged asymmetrically and off-center as is the case in the example shown. In this way it can be ensured that the lock 7 can be installed only in a certain position on the circuit breaker 1. In particular, installation of the lock 7 in a position that is rotated by 180° relative to the permitted position is to be prevented.

In the example shown, two measures were thus taken in order to prevent installation of the lock 7 in a position that was not intended. This is particularly safe, but in principle even one of the measures mentioned for preventing incorrect operation of the lock 7 is adequate.

In conclusion, it should be noted that the arrangement is not necessarily shown to scale and can therefore also have other proportions. Furthermore, the arrangement can also have more or fewer components than shown. Positions (e.g. “above”, “below”, “left”, “right”, etc.) relate to the respective drawing being described and in the event of a change in position are to be adapted accordingly to the new position. Finally, it should be noted that the above embodiments and developments of the invention can be combined in any way.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. An arrangement, comprising:
a circuit breaker including an actuating element configured to switch the circuit breaker on and off; and
a lock including a main body including a cutout configured to receive the actuating element and including a projection, which can be moved relative to the main body and corresponds to an opening or recess in the circuit breaker and can be brought into engagement with the opening or recess,
wherein the projection is mounted in a slide which is displaceable relative to the main body and extends obliquely relative to its direction of displacement and to the direction of displacement of the projection or has at least one such portion.

2. The arrangement of claim 1, wherein the projection that has been brought into engagement prevents a movement of the lock relative to the circuit breaker in a horizontal direction or transversely to an actuation direction of the actuating element.

3. The arrangement of claim 1, wherein the projection is formed by a pin that is displaceable relative to the main body.

4. The arrangement of claim 1, wherein the circuit breaker includes a housing, terminals arranged in the housing, openings provided in the housing for actuating the terminals, and a region that is elevated relative to the openings in which the actuating element for switching the circuit breaker on and off is arranged, and
wherein the main body of the lock encloses the elevated region of the circuit breaker.

5. The arrangement of claim 4, wherein the actuating element is arranged asymmetrically and off-center in the elevated regions; and
wherein the cutout for receiving the actuating element is arranged asymmetrically and off-center in the main body of the lock relative to the elevated region.

6. The arrangement of claim 1, wherein the opening or recess in the circuit breaker, which corresponds to the projection, is arranged asymmetrically and off-center.

7. The arrangement of claim 1, wherein the slide can be actuated using a rotatably mounted lever.

8. The arrangement of claim 1, further comprising:
a slide shifter, including the slide, and including a further opening, which can be moved out of the main body by moving the slide shifter or can be aligned with the opening in the main body.

9. The arrangement of claim 8, wherein the main body includes an additional opening, past which the slide shifter can be moved.

10. The arrangement of claim 8, further comprising:
a shackle lock passed through the further opening.

11. A lock for a circuit breaker, comprising:
a main body including a cutout configured to receive an actuating element of the circuit breaker; and
a projection that can be moved relative to the main body and corresponds to an opening or recess in the circuit breaker and can be brought into engagement with the opening or recess,
wherein the projection is mounted in a slide that is displaceable relative to the main body and extends obliquely relative to a direction of displacement thereof and to the direction of displacement of the projection or has at least one such portion.

12. The lock of claim 11, wherein the main body includes protrusions designed to enclose the circuit breaker.

13. The lock of claim 11, wherein the cutout (9) for receiving the actuating element (6) of the circuit breaker (1) is arranged asymmetrically and off-center in the main body (8) of the lock (7).

14. The arrangement of claim 1, further comprising:
a slide shifter, including a lever including a further opening, which can be moved out of the main body by moving the lever or can be aligned with an opening in the main body.

15. The arrangement of claim 14, wherein the main body includes an additional opening, past which the lever can be moved.

16. The arrangement of claim 14, further comprising:
a shackle lock passed through the further opening.
